(19) United States
(12) Patent Application Publication
(10) Pub. No.: US 2025/0131155 A1
(43) Pub. Date: Apr. 24, 2025

(54) APPARATUS AND METHOD FOR SIMULATING CHARGE AND DISCHARGE ENERGY IN INTERMITTENT COMPUTING SYSTEM

(71) Applicant: ELECTRONICS AND TELECOMMUNICATIONS RESEARCH INSTITUTE, Daejeon (KR)

(72) Inventors: Kwang Yong LEE, Daejeon (KR); Young Bin KIM, Daejeon (KR); Yoo Jin LIM, Daejeon (KR); Chae Deok LIM, Daejeon (KR); Jung Eun CHA, Daejeon (KR)

(21) Appl. No.: 18/679,870

(22) Filed: May 31, 2024

(30) Foreign Application Priority Data
Oct. 20, 2023 (KR) 10-2023-0141307
Dec. 26, 2023 (KR) 10-2023-0191660

(51) Int. Cl. G06F 30/20

(52) U.S. Cl. CPC G06F 30/20

(57) ABSTRACT

Proposed are an apparatus and a method for simulating charge and discharge energy in an intermittent computing system. Specifically, an operation method for simulating power instability in intermittent computing includes receiving at least one selected from a group of energy storage and SBC standard information of an intermittent computing system, energy consumption information for an application program of the intermittent computing system, and illuminance information, and generating an intermittent computing charge and discharge energy scenario model on the basis of the received information, and performing intermittent computing energy simulation on the basis of the generated model, and identifying whether a result of the simulation is appropriate.

### CROSS REFERENCE TO RELATED APPLICATION

The present application claims priority to Korean Patent Application No. 10-2023-0141307, filed 20 Oct. 2023, and Korean Patent Application No. 10-2023-0191660, filed 26 Dec. 2023, the entire contents of which are incorporated herein for all purposes by this reference.

### BACKGROUND OF THE INVENTION

### Field of the Invention

The present disclosure relates generally to a computing system. More particularly, the present disclosure relates to an apparatus and a method for simulating charge and discharge energy in an intermittent computing system.

### Description of the Related Art

### [Intermittent Computing System]

An intermittent computing system refers to a technology that operates and secures computing reliability using power obtained through energy harvesting, without commercial power sources or batteries in an environment in which power supply is unstable. This technology uses a small capacitor instead of commercial power sources batteries, and collects or regenerates ambient energy, such as solar, thermal, wind, or radio wave energy, to use the ambient energy as electrical energy. In addition, this is also called an intermittent computing technology because it is necessary to secure software data consistency and reliability even in an intermittent power on/off environment. For the intermittent computing system capable of collecting, storing, and transmitting data, an energy harvesting device technology and a technology for interworking with software required for the device are primarily required. In addition, it is necessary to secure the following technologies: a memory information maintenance technology for maintaining the consistency of data even when power is intermittently supplied or discontinued; a technology for managing an intermittent computing programming model required for correct and appropriate execution, and the flow of execution control; and a technology for embedding in a target device, such as a single-board computer (SBC).

The foregoing is intended merely to aid in the understanding of the background of the present disclosure, and is not intended to mean that the present disclosure falls within the purview of the related art that is already known to those skilled in the art.

### SUMMARY OF THE INVENTION

The present disclosure is directed to providing an apparatus and a method for simulating charge and discharge energy in an intermittent computing system.

In addition, the present disclosure is directed to providing an apparatus and a method for modeling various power instability situations by inputting standards of an energy storage of an intermittent computing system and operation standards of a single-board computer (SBC), or by inputting job energy consumption pattern data of an intermittent computing application.

In addition, the present disclosure is directed to providing an apparatus and a method for optimizing energy consumption of an intermittent computing application on the basis of a model obtained by modeling a power instability situation.

In addition, the present disclosure is directed to providing an apparatus and a method for determining, on the basis of a model obtained by modeling a power instability situation, operation standards of an energy storage and an SBC optimized for an installation place.

In addition, the present disclosure is directed to providing an apparatus and a method for determining, on the basis of a model obtained by modeling a power instability situation, standards of a solar panel of a solar cell-based light energy harvesting device.

In addition, the present disclosure is directed to providing an apparatus and a method for determining, on the basis of a model obtained by modeling a power instability situation, the number of times that intermittent computing job execution is performed and the time, and a checkpoint time point, accordingly.

In addition, the present disclosure is directed to providing an apparatus and a method for determining, on the basis of a model obtained by modeling a power instability situation, voluntary power off processing of an SBC and a power off time point for efficient energy harvesting and improved intermittent computing responsiveness.

According to various embodiments of the present disclosure, there is provided an operation method for simulating power instability in intermittent computing, the operation method including: receiving at least one selected from a group of energy storage and SBC standard information of an intermittent computing system, energy consumption information for an application program of the intermittent computing system, and illuminance information; generating an intermittent computing charge and discharge energy scenario model on the basis of the received information; performing intermittent computing energy simulation on the basis of the generated model; and identifying whether a result of the simulation is appropriate.

According to various embodiments of the present disclosure, there is provided an apparatus for simulating power instability in intermittent computing, the apparatus including at least one processor, wherein the at least one processor is configured to receive at least one selected from a group of energy storage and SBC standard information of an intermittent computing system, consumption information for an energy application program of the intermittent computing system, and illuminance information, generate an intermittent computing charge and discharge energy scenario model on the basis of the received information, perform intermittent computing energy simulation on the basis of the generated model, and identify whether a result of the simulation is appropriate.

According to various embodiments of the present disclosure, there is provided a non-transitory computer-readable storage medium storing at least one program including instructions, wherein when executed by an apparatus for simulating power instability in intermittent computing, the instructions cause the apparatus to receive at least one selected from a group of energy storage and SBC standard information of intermittent an computing system, energy consumption information for an application program of the intermittent computing system, and illuminance information, generate an intermittent computing charge and discharge energy scenario model on the basis of the received information, perform intermittent computing energy simulation on the basis of the generated model, and identify whether a result of the simulation is appropriate.

According to various embodiments of the present disclosure, the apparatus and the method find an optimal solution appropriate for an environment condition through various scenario models before an intermittent computing system is installed in an actual environment, without trial and error and wasted costs, such as re-installation, thus enabling the intermittent computing system with high reliability to be built.

Effects that may be obtained from the present disclosure will not be limited to only the above described effects. In addition, other effects which are not described herein will become apparent to those skilled in the art from the following description.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1A shows an example of using an energy harvesting device to drive a computing system, according to various embodiments of the present disclosure;

FIG. 1B shows capacitor energy charge and discharge characteristics, according to various embodiments of the present disclosure;

FIG. 1C shows a graph of capacitor energy charge and discharge characteristics of an intermittent computing system, according to various embodiments of the present disclosure;

FIG. 1D shows a graph of measurement of the amount of energy generation based on a solar panel, according to various embodiments of the present disclosure;

FIG. 1E shows an illuminance-current output estimation graph, according to various embodiments of the present disclosure;

FIG. 1F shows an example of calculation of an illuminance-current output estimation value, according to various embodiments of the present disclosure;

FIG. 1G shows an example of an intermittent computing energy scenario model, according to various embodiments of the present disclosure;

FIG. 2 shows another example of an intermittent computing energy scenario model, according to an embodiment of the present disclosure;

FIG. 3 shows an operation method of simulating a power instability situation in intermittent computing, according to an embodiment of the present disclosure;

FIG. 4 shows an entity relationship diagram of a method of generating an intermittent computing scenario model, according to an embodiment of the present disclosure;

FIG. 5 shows an example of entity tables of an intermittent computing scenario model, according to an embodiment of the present disclosure;

FIG. 6 shows a detailed operation method for an intermittent computing scenario model, according to an embodiment of the present disclosure;

FIG. 7 shows a flowchart of a job division method, according to an embodiment of the present disclosure;

FIG. 8 shows an example of a job division operation, according to an embodiment of the present disclosure;

FIG. 9 shows a flowchart of a method of constructing a charge model, according to an embodiment of the present disclosure;

FIG. 10 shows a flowchart of a method of constructing a discharge model, according to an embodiment of the present disclosure;

FIG. 11 shows another example of a job division operation, according to an embodiment of the present disclosure;

FIG. 12 shows an intermittent computing energy simulation operation method, according to an embodiment of the present disclosure;

FIG. 13 shows an operation method for displaying movement of a charge section current line and current time point energy data, according to an embodiment of the present disclosure;

FIG. 14 shows an operation method for displaying movement of a discharge section current line and current time point energy data, according to an embodiment of the present disclosure;

FIG. 15 shows a configuration diagram of an apparatus for simulating power instability in intermittent computing, according to various embodiments of the present disclosure;

FIG. 16A shows a first example of a screen for simulating power instability in intermittent computing, according to an embodiment of the present disclosure;

FIG. 16B shows a second example of a screen for simulating power instability in intermittent computing, according to an embodiment of the present disclosure;

FIG. 16C shows a third example of a screen for simulating power instability in intermittent computing, according to an embodiment of the present disclosure; and

FIG. 16D shows a fourth example of a screen for simulating power instability in intermittent computing, according to an embodiment of the present disclosure.

### DETAILED DESCRIPTION OF THE INVENTION

The terms used in the present disclosure are merely used to describe a particular embodiment, and are not intended to limit the scope of another embodiment. An expression used in the singular encompasses the expression of the plural, unless it has a clearly different meaning in the context. All the terms including technical and scientific terms used herein have the same meaning as commonly understood by those skilled in the art to which the present disclosure belongs. Among the terms used in the present disclosure, the terms defined in a general dictionary may be interpreted to have the meanings the same as or similar to the contextual meanings in the relevant art, and are not to be interpreted to have ideal or excessively formal meanings unless explicitly defined in the present disclosure. In some cases, even the terms defined in the present disclosure should not be interpreted to exclude the embodiments of the present disclosure.

In various embodiments of the present disclosure to be described below, a hardware approach will be described as an example. However, the various embodiments of the present disclosure include a technology using both hardware and software, so the various embodiments of the present disclosure do not exclude a software-based approach.

In addition, in the detailed description and claims of the present disclosure, the expression “at least one of A, B, and C” mean “only A”, “only B”, “only C”, or “any combination of A, B, and C”. In addition, the expression “at least one of A, B, or C” or “at least one of A, B, and/or C” may mean “at least one of A, B, and C”.

Hereinafter, the present disclosure relates to an apparatus and a method for simulating charge and discharge energy in an intermittent computing system. Specifically, the present disclosure relates to an intermittent computing technology that uses a semipermanent energy storage, such as a capacitor, to avoid replacing IoT device batteries in monitoring and management devices for social infrastructure facilities with extremely limited access among national, city, and social infrastructure facilities, intelligent wearable or implantable devices, and IoT devices, such as small satellites, used in extreme environments with unstable power supply, and that enables continuous computing through combination of self-power generation and a non-volatile memory technology.

More specifically, the present disclosure relates to a charge/discharge energy simulation technology for an intermittent computing system, which is expected to be used in charge/discharge energy simulation experiment and energy standard analysis for the intermittent computing system.

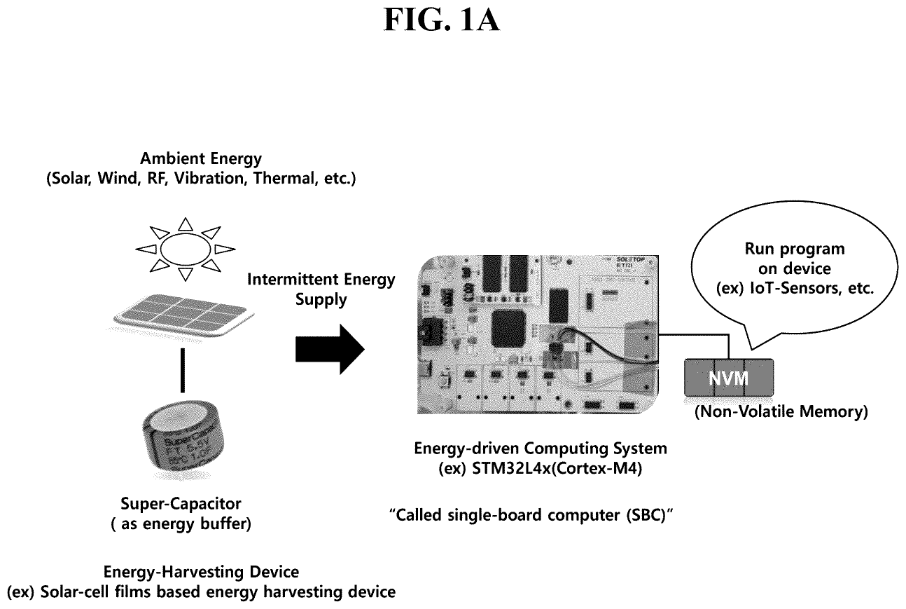

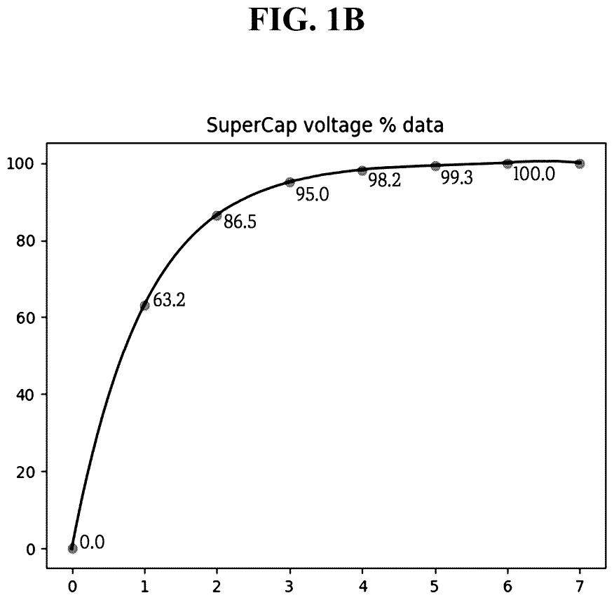

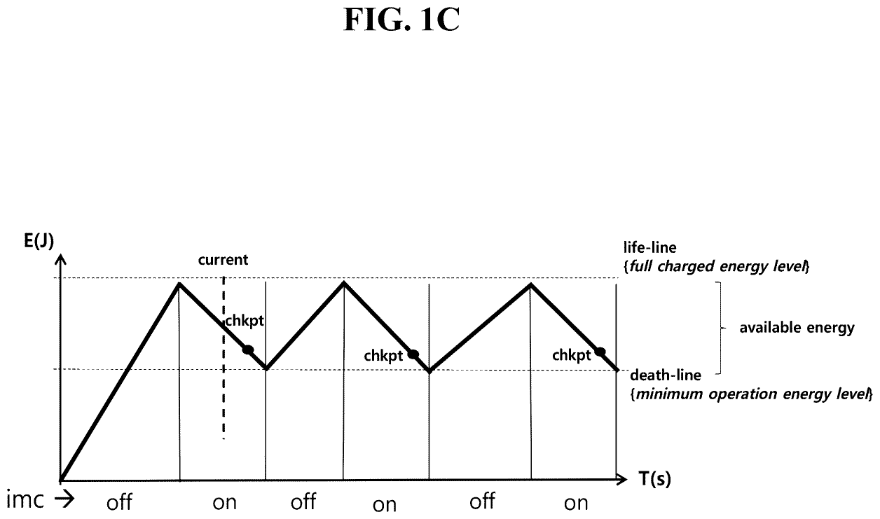

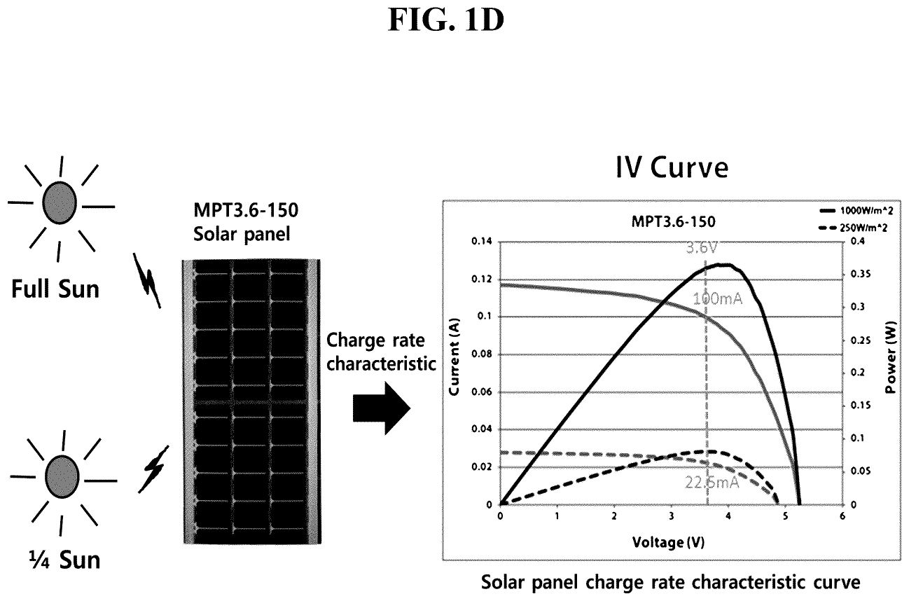

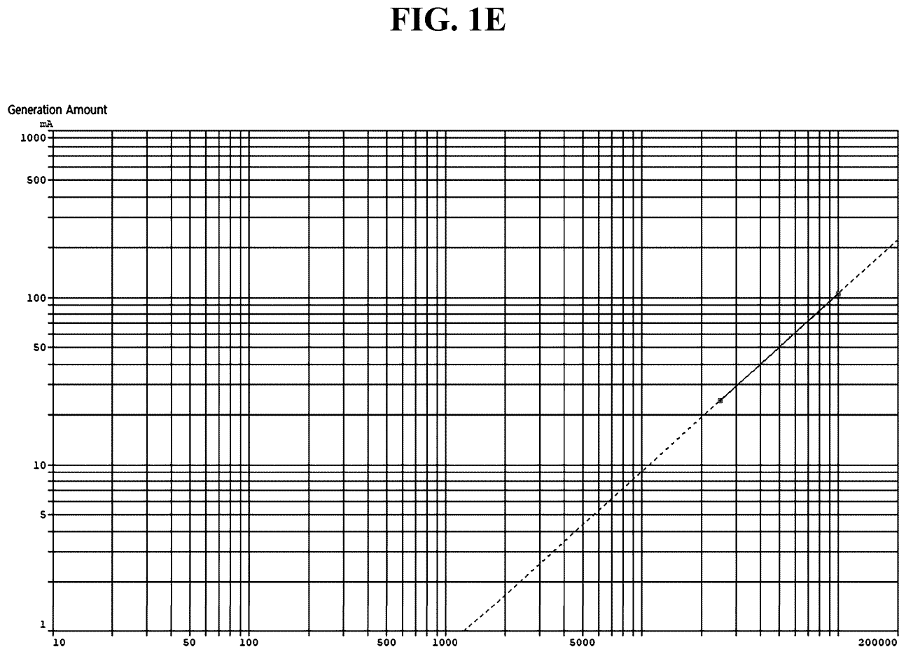

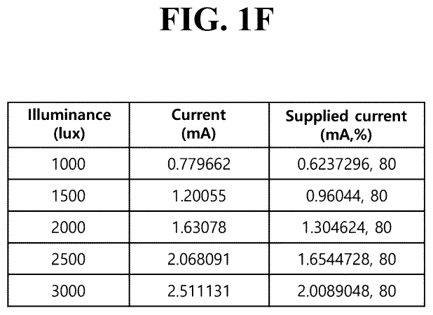

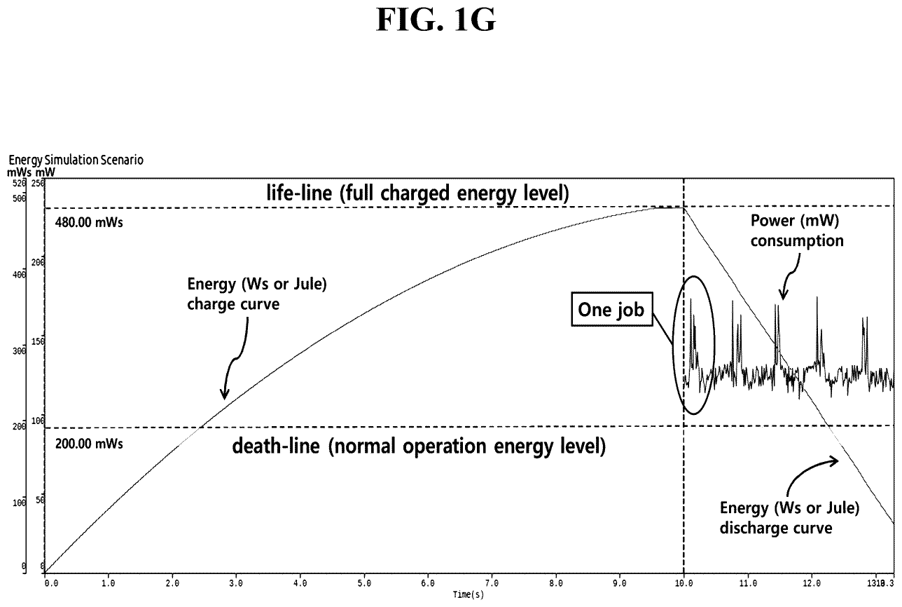

FIG. 1A shows an example of using an energy harvesting device to drive a computing system, according to various embodiments of the present disclosure.

Referring to FIG. 1A, ambient energy may refer to energy present in the form of sunlight, wind, radio frequency (RF), vibration, or heat. The ambient energy may be harvested by an energy harvesting device. As an example of the energy harvesting device, there is an energy harvesting device based on a solar-cell film.

The energy harvested from the ambient energy may be stored and managed by a super capacitor. The super capacitor is used as an energy buffer. When energy is intermittent, the super capacitor stores the energy, and provides the energy to an energy-driven computing system when needed.

By using the super capacitor, energy may be intermittently supplied to the energy-driven computing system. The energy-driven computing system may use harvested energy to perform computing tasks. As an example of the energy-driven computing system, there is STM32L4x (Cortex-M4).

The energy-driven computing system is connected to a non-volatile memory (NVM) so that data is preserved even after power is turned off, whereby data loss is prevented even when energy is intermittently supplied. The NVM may be an integral part of “Run program on device” in which a program is executed on a device, such as an IoT sensor.

In this way, a computer that includes the energy-driven computing system and the NVM and integrates all necessary computing functions on a single board is called a single-board computer (SBC).

### [Capacitor Energy Charge and Discharge Characteristics]

FIG. 1B shows capacitor energy charge and discharge characteristics, according to various embodiments of the present disclosure.

A SuperCap may refer to a capacitor with a relatively large capacity among capacitors. A capacitor-based energy harvesting device and an SBC are connected and interworking test is performed, then the following computing characteristics may be achieved.

(1) Energy harvesting charges an energy storage from the charge voltage of 0 V to the maximum charge voltage, and power is supplied to the SBC through discharge. The energy charge characteristics of the capacitor act as shown in Equation 1.

$$V ( t ) = {V}_{0} ( 1 - {e}^{- t / RC} ) \qquad [ Equation 1 ]$$

Herein, V(t): internal voltage (V) of capacitor, V0: external voltage (V), t: time (second), R: resistance (Ω), C: capacitance (F) of capacitor

Referring to FIG. 1B, FIG. 1B shows a characteristic curve when the external voltage is 1 V, the resistance is 1 kΩ, and the capacitance of the capacitor is 1000 μF.

RC, the product of the resistance and the capacitance, is called the time constant. This time constant has the following characteristics.
Charging for the time indicated by the time constant will charge about 63.21% of the total capacity, that is, 0.63 V
Charging 6 times the time constant will charge 100%, that is, 1.0 V
The greater the resistance or the capacitance, the longer it takes to charge (the longer the time constant)
The SBC operates by being repeatedly charged/discharged within the normal operation section after the energy in the energy storage is consumed, depending on the operation of the SBC
The charging/discharging of a power module in energy harvesting has a non-linear characteristic, and a simulation device estimates the capacity of the energy storage through approximation generally with a linear model
As shown in Equation 2, the total energy (E, unit: Ws or Jule) stored in the energy storage is proportional to the square of the capacitance (C, unit: Farad) of the capacitor and the charge voltage (V, unit: Voltage)

$$E = \frac{1}{2} \times C \times {V}^{2} ( Ws ) \qquad [ Equation 2 ]$$

Accordingly, as shown in FIG. 1C, only the charge/discharge voltage range of the 1F capacitor, 5 V to 3.3 V is available for energy. The greater the charge/discharge voltage range, the greater the amount of available energy.

$$Capacitor = F , 5 V , SBC = 3.3 V MAXE = \frac{1}{2} \times 1 \times {5}^{2} = 12.5 ( Ws ) MINE = \frac{1}{2} \times 1 \times 3 . {3}^{2} = 5.4 \; 45 ( Ws ) AvailableE = MAXE - MINE = 12.5 - 5.445 = 7.0 \; 55 ( Ws ) \qquad [ Equation 3 ]$$

FIG. 1C shows a graph of capacitor energy charge and discharge characteristics of an intermittent computing system, according to various embodiments of the present disclosure.

Referring to FIG. 1C, a greater value of the energy storage increases the length of time the SBC connected to the energy harvesting device is operable, but it takes a lot of time to charge, which may be ineffective. Therefore, it is necessary to select the optimal energy standard value appropriate for an application program running on the SBC.

That is, the capacity of the energy storage needs to be selected so that the amount of energy available for supply within the normal operation section, that is, between the full charge energy level (MaxE) and the minimum operation energy level (MinE), is equal to or greater than the energy required for the system to operate, on the basis of the energy consumption of an application program embedded in the SBC.

### [Measurement of Amount of Energy Generation Based on Solar Panel]

FIG. 1D shows a graph of measurement of the amount of energy generation based on a solar panel, according to various embodiments of the present disclosure.

Referring to FIG. 1D, when an energy harvesting device based on a solar panel (solar cell film) is installed, as one method of estimating the efficiency of a solar panel without measuring irradiance at the installation location, the following charge rate characteristic graph may be considered. Using a current-voltage curve, also known as an IV curve, the amount of charge current at a particular voltage is estimated. In the case of MPT3.6-150 (produced by Power Film) shown in FIG. 1D, at 3.6 V, charging under 14-sun illuminance produced the current of 22.5 mA and charging under full-sun illuminance produced the current of 100 mA. In general, full-sun is 100,000 lux, and ¼-sun is 25,000 lux.

FIG. 1E shows an illuminance-current output estimation graph, according to various embodiments of the present disclosure.

Referring to FIG. 1E, FIG. 1E shows a characteristic graph for estimating current output with the output of 3.3 V as an example of an illuminance-dependent current output graph of the MPT3.6-150 solar panel. First, from the current-voltage (IV) characteristic curve, two points (25,000 lux, 24 mA) and (100,000 lux, 105 mA) are found, and then the current output for illuminance is estimated with the equation of a straight line. Y=aX+b, the equation of a straight line, is used to calculate the slope a and the intercept b and estimate the current output y value for any illuminance x. Herein, the values on the x and y axes are calculated by a common log function. An example of this is shown in Equation 4.

$$Input : 2 points ( 25000 lux , 24 mA ) , ( 1 \; 00000 lux , 105 mA ) \text{=>} X : log ( x ) , Y : log ( y ) , Y = aX + b \text{=>} \\ ( X 1 , Y 1 ) = ( 4.3 \; 9794 , 1.380211 ) , ( X 2 , Y 2 ) = ( 52.0211 \; 89 ) \text{=>} \\ a = \frac{( Y 2 - Y 1 )}{( X 2 - X 1 )} = \frac{( 2.021189 - 1.380211 )}{( 5 - 4.39794 )} = 1.064642 b = Y 1 - aX 1 = - 3 \text{.30202} \text{=>} \\ y = {10}^{a \times log ( x ) + b} = {10}^{1.064642 \times log ( x ) - 3.30202} ( unit : mA ) \qquad [ Equation 4 ]$$

FIG. 1F shows an example of calculation of an illuminance-current output estimation value, according to various embodiments of the present disclosure.

Referring to FIG. 1F, when illuminance is input as shown in column 1 of FIG. 1F, the associated current output may be estimated. Herein, more precise estimation may be achieved by applying the energy supply efficiency (%) of the energy harvesting device. For example, considering the device with the supply efficiency of 80%, the value of the amount of current is multiplied by 0.8 for use.

### [Intermittent Computing Energy Scenario Model]

FIG. 1G shows an example of an intermittent computing energy scenario model, according to various embodiments of the present disclosure.

An energy harvesting method of an energy harvesting device for intermittent computing includes the steps of energy generation (collection), energy storage (charge), and energy consumption (discharge). In order to efficiently use the harvested energy in the energy consumption step, the job execution time of an intermittent computing application program is artificially controlled, thereby achieving efficient energy storage and consumption.

When “intermittent computing energy scenario modeling” is defined as planning efficient energy harvesting, storage, and consumption by linking the job execution time of the intermittent computing application program with the steps from ambient energy generation (supply) to storage and consumption, a model generated by this scheduling result may be referred to as an “intermittent computing energy scenario model”.

Referring to FIG. 1G, FIG. 1G shows an example of the intermittent computing energy scenario model according to the present disclosure, wherein the x axis represents the time axis and the y axes represent two axes representing the amount of energy charge/discharge and the power consumption of application, respectively. In this case, the state of charge of the capacitor by the energy harvesting device and the depth of discharge of energy caused by the application operation in the SBC were modeled. In addition, execution of jobs of application needs at least five times. However, after execution three times, the energy drops below the death-line. Therefore, it can be found that it is necessary to either replace the energy storage with a larger capacity, or change the energy scenario model so that a shutdown is forced after execution three times and then when the energy is charged, execution of jobs the remaining two times continues. In order for these decisions to be made, the present disclosure proposes a tool technology for generating an optimal intermittent computing energy scenario model by using an intermittent computing system simulation technique of the present disclosure.

### Problems in Related Art

Regarding the characteristic of an intermittent computing system, since the energy accumulated in the capacitor is very limited, power interruption occurs while a program is executed and recharging takes place through self-power generation, and when charging is completed, discharging takes place to execute the program. This process is repeated. Herein, unlike existing systems, when power is supplied to an embedded computing target device or a single-board computer (SBC) device, the program is not restarted from the interrupted state, but is re-executed from the beginning. As a result, a problem may occur in which only the initial state is repeated without making any computing of the program. To solve this problem, in the related art, intermittent computing sets checkpoints for the progress of a program while the program is being executed. Through this, when charging is completed and discharging takes place and the program is restarted from the beginning, returning (rollback) to the position set as a checkpoint in the previous step and the execution of the program continues.

In addition, developers produce an energy harvesting device, such as a solar electrical energy collection device, for collecting energy directly from the surrounding environment, and build an intermittent computing environment, and develop, verify, and optimize an application program. However, this is time-consuming, and it is difficult to organize a multi-state intermittent computing environment. Even if H/W is produced, it is difficult to reproduce an electrical energy situation and an intermittent discharge situation gradually collected in actual environment conditions. For example, when devices, such as curve derivation electronic display boards, indicator lights, or forest trail guidance lights that charge energy during the day using an energy harvesting device based on a solar film and turn on LED lights at night, using a solar cell-based light energy harvesting system technology are developed, power monitoring tools or power measurement devices are then used to measure the energy consumption of an SBC device in which an intermittent computing application program is provided, and energy consumption statistics are generated. Then, the energy storage for handling the energy consumption is selected or applied.

However, the problem of using a power monitoring device is the result of not sufficiently examining power instability situations of energy harvesting, such as the shade of the energy harvesting device or cloudy weather, resulting in inappropriate energy harvesting time (charging time) and installation of an energy harvesting system including an inappropriate energy storage (capacitor). Specifically, a device that is charged during the day and displays road speed limits with LEDs at night applies inadequate energy standards, making it difficult to operate properly. In the worst case, after repeated trial and error, including several hardware re-productions and re-installations, replacement with a battery-based 220V constant power supply device is made and re-installation is performed, resulting in wasted costs.

Therefore, this disclosure proposes the following as a way to address these problems.

### Technical Solution

To solve the problems in the related art, such as checkpoint and rollback processing problems of the intermittent computing system, problems with configuration and production of an optimal energy device harvesting suitable for an intermittent computing application, and problems in considering various power instability situations for ambient energy harvesting, the present disclosure proposes an intermittent computing energy simulation method based on an intermittent computing energy scenario model.

Simulation means a technique for performing experiments through a model obtained by simply modeling a real situation, and for making actions or decisions depending on the result of the experiments. In general, before actually producing or installing a system, simulation methods are used for sufficient examination or experiment or decision-making.

In a simulation method of the present disclosure, standards of an energy storage of an intermittent computing system, operation standards of an SBC, and job energy consumption pattern data of an intermittent computing application are input to model various power instability situations, and various situations are examined by applying the generated models, and according to the analysis results, the following optimal decisions are made.
Optimization of energy consumption of the intermittent computing application (optimal energy scheduling)
Determination operation standards of an energy storage and an SBC optimized for an installation place
Determination of standards of a solar panel of a solar cell-based light energy harvesting device
Determination of the number of times that intermittent computing job execution is performed and the time, and a checkpoint time point, accordingly
Determination of voluntary power off processing of an SBC and a power off time point for efficient energy harvesting and improved intermittent computing responsiveness

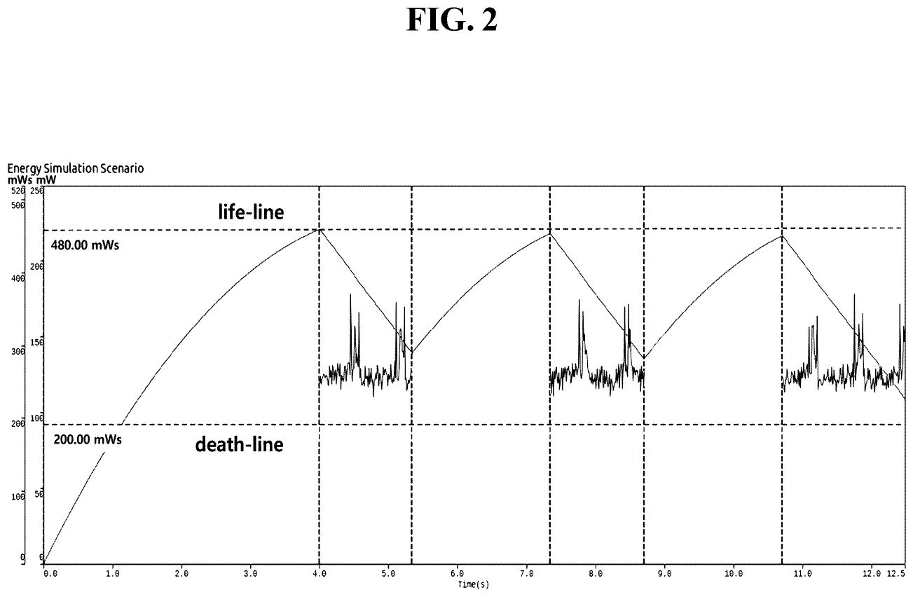

FIG. 2 shows another example of an intermittent computing energy scenario model, according to an embodiment of the present disclosure.

Referring to FIG. 2, one intermittent computing scenario model is shown in which after initial charge, an intermittent computing application program performs job execution twice, and checkpoint processing, voluntary SBC power off processing, recharge, SBC power on processing, and rollback processing take place in that order, and jumping to a checkpoint time point takes place to continue computing processing.

The model shown in FIG. 2 may be used to determine the optimal energy standards appropriate for the intermittent computing system, and the time points of actions, such as checkpoint or rollback, and SBC power off processing.

Referring to FIG. 2, job execution is performed twice, and after 1.2 seconds, voluntary SBC power off processing is required for checkpoint processing and charge. Herein, the capacitor needs to be able to collect up to 480 mWs. In addition, it needs to be able to supply the energy of 200 mWs or more for SBC operation. Accordingly, the intermittent computing system in which charging for 2 to 4 seconds, computing for 1.2 seconds, and energy discharge takes place is configured.

The present disclosure is directed to providing an apparatus and a method for simulating a power instability situation that is as similar as possible to an actual intermittent computing system environment, by using an intermittent computing energy scenario model.

To this end, an embodiment may configure a method and an apparatus for generating intermittent computing scenario models that simulate power instability situations of a solar cell-based solar energy harvesting system, and for performing simulation and analysis through the models, for energy harvesting and consumption situations in various power instability environments before installation in the actual field.

Through the intermittent computing energy simulation technology of the present disclosure, virtual energy charge and discharge situations can be reproduced (simulated) and analyzed. From a software perspective, optical charge and discharge energy scheduling as well as optimal checkpoint time points and the optimal number of times for checkpoints in the intermittent computing application program can be identified. In addition, from a hardware perspective, the optimal energy storage capacity and the size standard of a solar cell film appropriate for a power instability situation can be determined. Ultimately, before an intermittent computing system is installed in an actual environment, pre-examination is performed through various scenario models, assisting in finding an optimal solution appropriate for an actual environment condition. Accordingly, without trial and error and wasted costs, such as re-installation, it is expected to help build an intermittent system with computing high reliability.

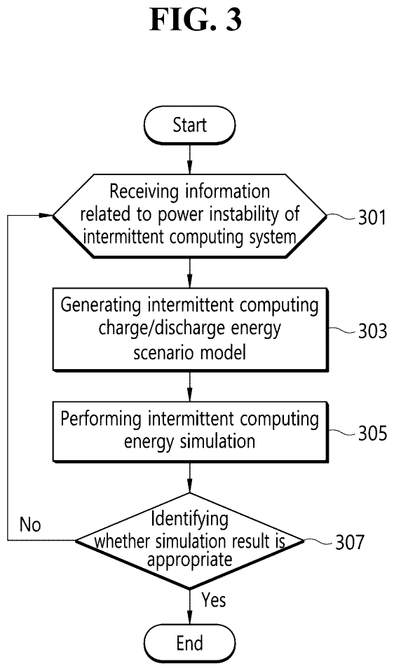

FIG. 3 shows an operation method of simulating a power instability situation in intermittent computing, according to an embodiment of the present disclosure.

Referring to FIG. 3, an apparatus (hereinafter, referred to as the “apparatus”) for simulating power instability in intermittent computing may receive information related to power instability of an intermittent computing system in step 301. The information related to power instability may include standard information of an energy storage and an SBC of the intermittent computing system, and (t,V,I) energy consumption pattern time series data of an application program, and (t,lux) illuminance time series data.

The apparatus may generate an intermittent computing charge and discharge energy scenario model in step 303. The intermittent computing charge and discharge energy scenario model may be generated through intermittent computing charge/discharge energy scenario modeling for obtaining an energy simulation model in the form of (t, V, I, Δt, E, Esum) time series data for various power instability situations on the basis of the information related to power instability in step 301.

The apparatus may perform intermittent computing energy simulation in step 305. Step 305 may include an intermittent computing energy simulation experiment analysis step in which on the basis of charge and discharge energy scenario models, step movement by Δt is made and simultaneously, energy consumption statistics in intermittent computing sections are generated and examined.

The apparatus may identify whether a simulation result is appropriate in step 307. When the result is not appropriate, the apparatus may perform step 301 again. When the result is appropriate, the apparatus may terminate the process.

### [Intermittent Computing Charge and Discharge Energy Scenario Modeling]

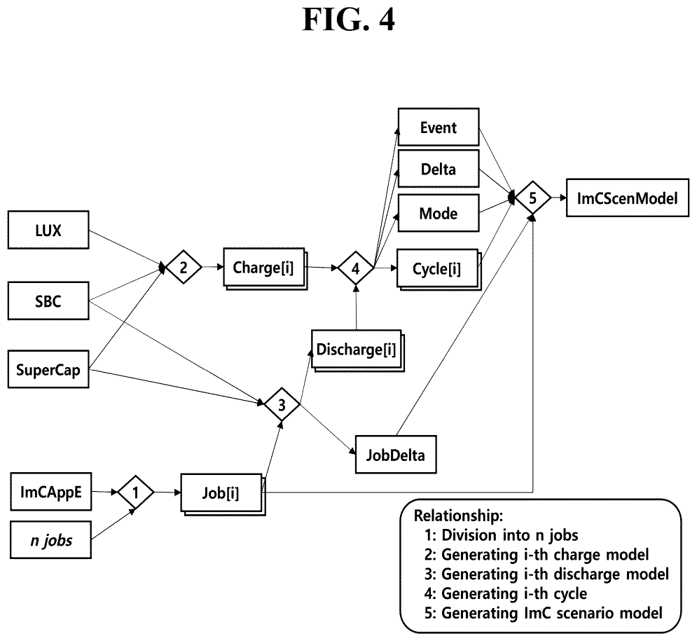

FIG. 4 shows an entity relationship diagram of a method of generating an intermittent computing scenario model, according to an embodiment of the present disclosure.

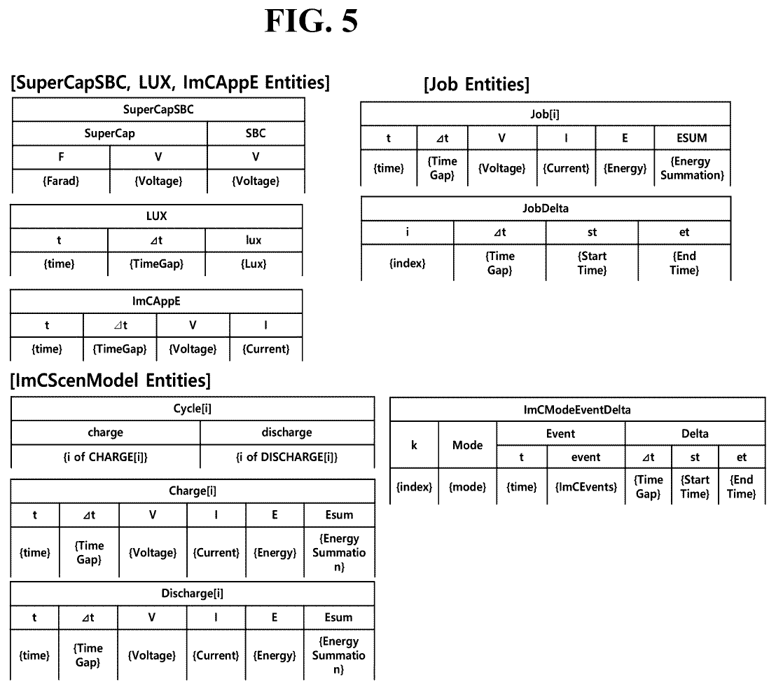

FIG. 5 shows an example of entity tables of an intermittent computing scenario model, according to an embodiment of the present disclosure.

Referring to FIGS. 4 and 5, the intermittent computing charge and discharge energy scheduling step is to construct an intermittent computing scenario model through modeling in the form of meta data, such as (t, V, I, Δt, E, Esum) charge and discharge time series data for various power instability situations, modes, events, and delta data. Herein, E denotes the energy over time Δt, that is, joules or watt-seconds (Ws), and Esum denotes the sum of Es or the total amount of energy subtracted during charge or discharge until time point t.

Referring to FIG. 5, FIG. 5 shows tables of attribute fields of entities for configuring the intermittent computing scenario model. For example, the attributes of the SuperCap entity, which is the energy storage, are a table of the Farad unit, F, and a voltage, V, in maximum charge. The SBC is a table entity of a normal operation voltage value, V. It can be seen that the LUX entity is time series data consist of a time value, t, in seconds, and a sampling interval, Δt, and an illuminance value, lux. The ImCAppE entity is time series data in the form of (t, Δt, V, I) of an application program, and is a table representing the average voltage V and I consumed during Δt at time point t. The ImCModeEventDelta table entity stores meta data for the intermittent computing scenario model in the “k” field in order starting from 1. The Mode attribute represents either “charge” mode or “discharge” mode. The Event entity is fields for recording the event at time point t, SBC power on “SBC_Power_On” or SBC power of “SBC_Power_Off”. The Delta field consists of start time st and end time et for each mode, and Δt representing the gap time between st and et.

Using these entities, a method of generating an ImC scenario model (ImCScenModel) may be constructed to process entity relationships in the following order (see FIG. 4).

1. Applying entity relationship 1, that is, dividing ImCAppE time series data to form n pieces of Job[i].

2. Applying entity relationship 2 to form n pieces of Charge[i]. Charge[i] may be generated with LUX (illuminance time series data), SBC (the normal operation voltage of the SBC), SuperCap (the amount of charge F of the SuperCap and the full charge voltage V) entities as inputs.

3. Applying entity relationship 3 to form n pieces of Discharge[i]. N SBCs, n SuperCaps, and n pieces of Discharge[i] may be formed.

4. Applying entity relationship 4 to merge Discharge[i] time series data after n pieces of Charge[i] time series data, thereby forming Cycle[i] time series data. Simultaneously, event information that represents charge and discharge modes and SBC_Power_On at a charge completion time point or SBC_Power_Off event at a discharge time point until a normal operation voltage time point is generated. Start time point, end time point, and section delta (gap) time information of Charge or Discharge sections may be formed.

5. Finally, applying entity relationship 5 to complete one ImCScenModel.

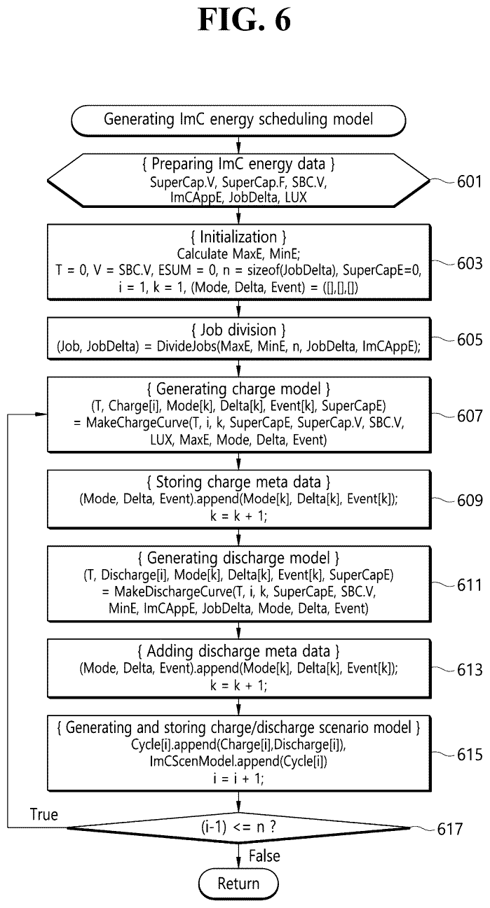

FIG. 6 shows a detailed operation method for an intermittent computing scenario model, according to an embodiment of the present disclosure.

Referring to FIG. 6, the apparatus may prepare energy data for an intermittent computing system in step 601. That is, in step 601, an intermittent computing (ImC) energy data preparation step is performed with SuperCap and SBC energy standard data (SuperCapSBC), and illuminance (LUX) and intermittent computing application energy (ImCAppE) data as input data. As a result, information, such as the voltage of the SuperCap (SuperCap. V), the capacitance of the SuperCap (SuperCap. F), the energy of the SuperCap (SuperCapE), the voltage of the SBC (SBC.V), ImCAppE, a job gap (JobDelta), and illuminance (LUX), may be obtained.

Accordingly, SuperCapE may be initialized to 0.

The apparatus may initialize the following execution variables in step 603. For example, these are shown in the table below.

MaxE = “the maximum charge energy value of the
SuperCap.”;
MinE = “the energy value charged in the SuperCap up to
the SBC normal operation voltage.”;
n = “the number n of job splits when ImCAppE is divided
into n jobs.”;
T = 0, V = SBC.V, Esum = 0, i = 1, k = 1;

The apparatus may use ImCAppE time series data as inputs for division into n jobs and may form job arrays in step 605. Herein, if possible, Esum of the last time point of one Job[i] is equal to or greater than the value MinE, and division is made in time (t) order of the ImCAppE time series data. For example, this is shown in the table below.

Job = {Job[1], ..., Job[i], ..., Job[n]};
Job[i][:] = {Job[i][1], ..., Job[i][j]},
Herein,
Job[i][j] : an element consisting of (t, V, I, [symbol] t, E,
Esum);
JobDelta = {JobDelta[1], ..., JobDelta[i], ..., JobDelta[n]};
which is a set,
JobDelta[i] : an element consisting of (i /* a job
sequence number, an integer value, 1 <= i <= n*/, [symbol]
t /* the time gap from start to end, a decimal. For
example, 200 usec, 0.0002 seconds*/,
st /*start time point*/, et /*end time point*/);

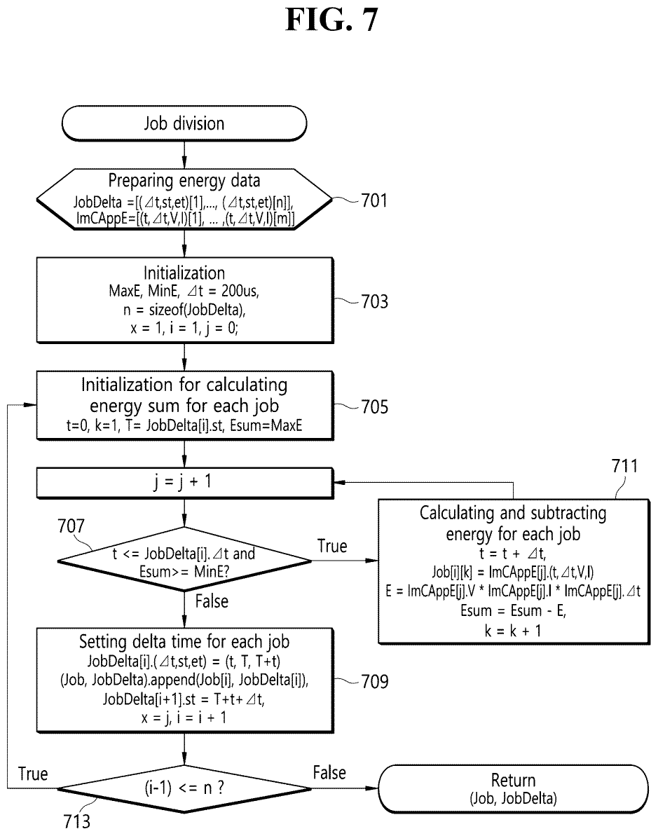

The detailed operation in step 605 will be described with reference to FIG. 7.

The apparatus may construct an i-th charge model (charge[i]) in step 607. That is, SBC. V, SuperCap. F, SuperCap.V data, and an illuminance time series data LUX array consisting of (T, Δt, lux) elements may be used to generate the following Charge[i] time series data. For example, this is shown in the table below.

T = T + [symbol] t,
t = t + [symbol] t,
Charge[i][:] = { Charge[i][1], ..., Charge[i][j], ...,
Charge[i][m]}
Herein,
Charge[i][j] : an element consisting of (T, V, I, [symbol] t, E,
Esum);
j : an integer, 1 <= j <= m;

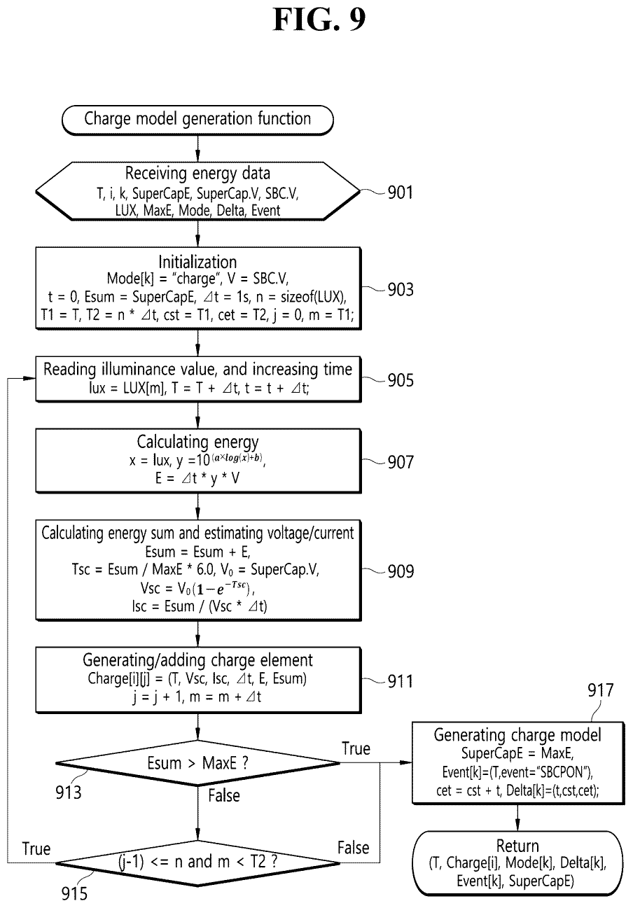

The detailed operation in step 607 will be described with reference to FIG. 9.

The apparatus may generate meta information data related to the charge model in step 609. The attribute values of ImCModeEventDelta may be calculated and stored as follows. Herein, k is a variable value set in step 603, and indicates the sequence number of the ImCModeEventDelta element. Since Charge[i][j].Δt is set to 1 second, T denotes a time point value increased by Δt m times, that is, increased by m seconds, starting from time point Charge[i][1].t. In addition, the SuperCapE variable value, which is the SuperCap full charge energy value, may be set to MaxE as follows. For example, this is shown in the table below.

ImCModeEventDelta[k].k = k
ImCModeEventDelta[k].Mode =“charge”
ImCModeEventDelta[k].Event.t = T
ImCModeEventDelta[k].Event.event = “SBC_Power_On”
ImCModeEventDelta[k].Delta.st = Charge[i][1].t
ImCModeEventDelta[k].Delta.et = Charge[i][m].t
ImCModeEventDelta[k].Delta.Δt = Charge[i][m].t − Charge[i][1].t
SuperCapE = MaxE
k = k + 1

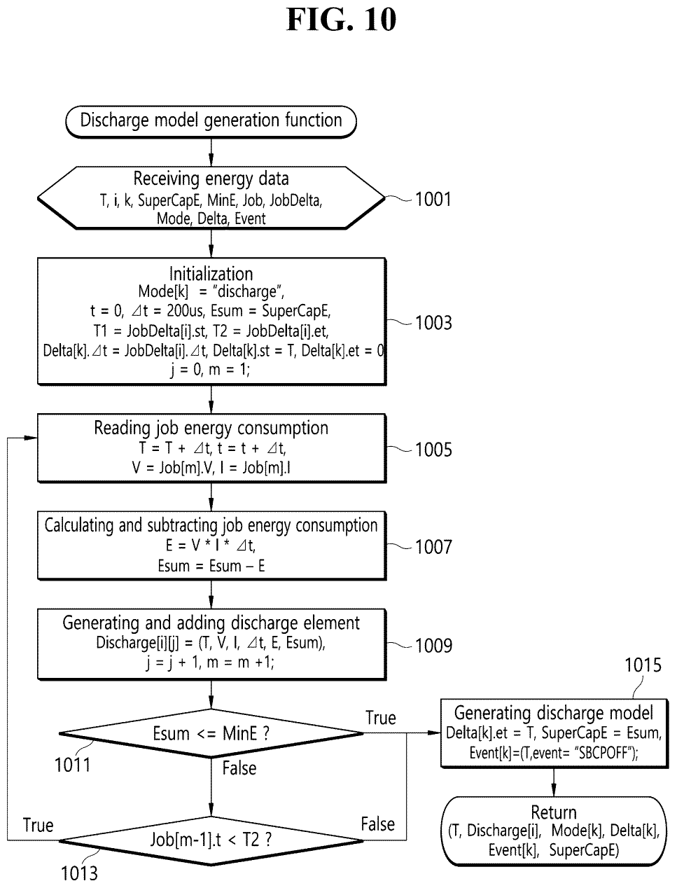

The apparatus may generate an i-th discharge model (Discharge[i]) in step 611. The detailed operation in step 611 will be described with reference to FIG. 10.

The apparatus may generate and add meta information data of the discharge model in step 613. For example, this is shown in the table below.

ImCModeEventDelta[k].k = k,
ImCModeEventDelta[k].Mode = “discharge”,
ImCModeEventDelta[k].Event.t = T,
ImCModeEventDelta[k].Event.event = “SBC_power_off”,
ImCModeEventDelta[k].Delta.st = Discharge[i][1].t,
ImCModeEventDelta[k].Delta.et = Discharge[i][m].t,
ImCModeEventDelta[k].Delta.Δt = Discharge [i][m].t −
Discharge[i][1].t,
SuperCapE = Discharge[i][m].Esum
k = k + 1

The apparatus may merge the charge model data with the discharge model data in order to generate and store a charge and discharge scenario model in step 615. That is, the charge and discharge scenario model may be generated and stored by merging the charge model data with the discharge model data in order and generating the following cycle (CYCLE(i)) data.

CYCLE [i] = {Charge[i][:]Discharge[i][:]}
i = i + 1

Herein, Discharge[i][j].t is updated as follows, and T may be set to the time point t of the last element of Discharge[i], that is, Cycle[i][last] element. For example, this is shown in the table below.

m = The number of elements of Discharge[i]
basetime = Charge[i][last].t
Forj=1..m,Discharge[i][1:j].t = basetime
+Discharge[i][1:j].t
T=Discharge[j][m].t

When i−1 is equal to or less than n, the apparatus may repeatedly perform steps 607 to 615. When i−1 is greater than n, intermittent computing scenario model data may be generated in step 617 on the basis of the models generated in steps 601 to 615.

FIG. 7 shows a flowchart of a job division method, according to an embodiment of the present disclosure. FIG. 7 may correspond to step 605 of FIG. 6.

Referring to FIG. 7, the apparatus may prepare energy data (JobDelta and ImCAppE) in step 701.

Afterward, the apparatus may perform initialization on MaxE, MinE, Δt, and other variables in step 703. For example, Δt may be set to 200 microseconds. x, i, and j may be indexes (counters) for iteration.

Afterward, the apparatus may perform initialization for calculating the sum of energy for each job in step 705. For example, initialization may be performed as follows: t=0, k=1, T=jobDelta[i].st, Esum=MaxE.

Afterward, the apparatus may identify whether the current time (t) is equal to or less than the end time (JobDelta[i].et) of a selected job and “Esum” is equal to or greater than “MinE” in step 707.

Afterward, the apparatus may set job delta time when the condition in step 707 is False. That is, when the condition is false, a new job delta may be added to the JobDelta array and the start and end times of a new job may be set to the current time t and a value obtained by adding Δt to t. Afterward, JobDelta[i+1].st may be set to T+Δt, and indexes x and i may be updated.

Alternatively, when the condition in step 707 is True, the apparatus may calculate and subtract the energy for each job in step 711. That is, the current time t may be updated, the JobDelta and ImCAppE arrays may be used to calculate the energy E to be consumed during the time, and the value may be subtracted from Esum. k is a job counter, which may be increased at each iteration.

The apparatus may determine whether to repeat in step 713. That is, it is determined whether i−1 is equal to or less than n, and iteration takes place until the entire job array is processed. When the condition is False, the above flowchart may terminate and the result (Job and JobDelta) may be returned.

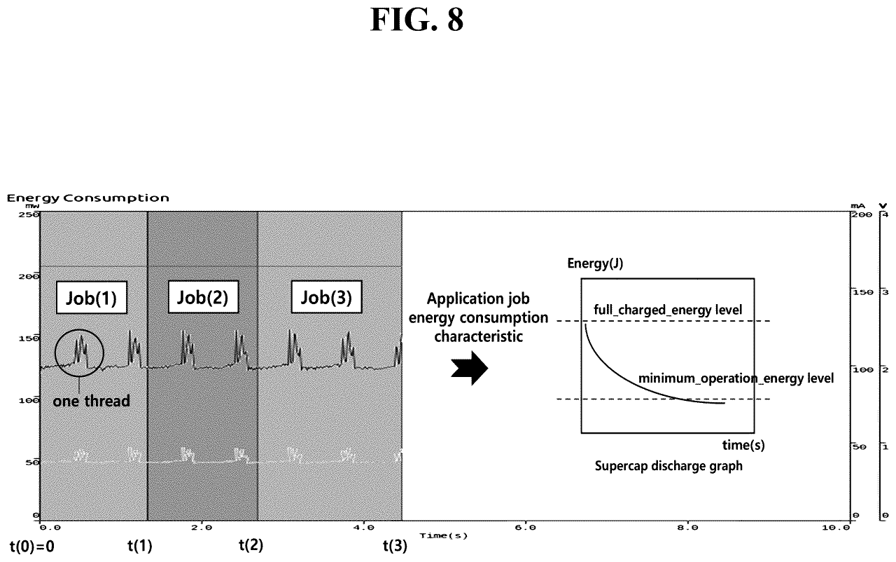

FIG. 8 shows an example of a job division operation, according to an embodiment of the present disclosure.

Referring to FIG. 8, FIG. 8 shows that jobs of an intermittent computing application are divided by two to construct three jobs: Job={Job[1], Job[2], Job[3]}.

FIG. 9 shows a flowchart of a method of constructing a charge model, according to an embodiment of the present disclosure. FIG. 9 may correspond to step 607 of FIG. 6.

Referring to FIG. 9, the apparatus may receive energy data in step 901. Specifically, the energy data may include the time (T), repeat counters (i and k), current and maximum voltages (SuperCapE, SuperCap.V) of the super capacitor, SBC voltage (SBC.V), illuminance (LUX), maximum energy (MaxE), mode (Mode), time gap (Delta), and event (Event).

The apparatus may initialize each of the variables in step 903. Specifically, the operation mode of the energy model may be set to the charge mode, and the current voltage may be initialized to the SuperCap voltage. In addition, the time gap may be set to 1 nanosecond, the total times (T1 and T2) may be calculated on the basis of the array size (n) of LUX, and repeat counter variables may be initialized.

The apparatus may read the illuminance value and increase the time in step 905. Specifically, the current illuminance (“lux”) may be read from the LUX array, and the time may be updated (T=T+Δt, t=t_Δt).

The apparatus may calculate the energy in step 907. Specifically, the energy consumption (E) may be calculated on the basis of the illuminance (LUX).

The apparatus may calculate the energy sum and estimate the voltage and current in step 909. Specifically, the total energy consumption (E) may be updated, and the voltage (Vsc) and current (Isc) of the SuperCap may be calculated.

The apparatus may generate or add a charge element in step 911. In step 911, Charge[i][j]=(T, V, I, Δt, E, Esum) element may be generated with one (T, Δt, lux) element at the T time point of the LUX data as input.

Using Equation 5, x=lux is input to estimate the amount of generated current y (unit: Ampere). Herein, a and b may be slope (unit: float) and intercept (unit: float) constant values of the illuminance-based energy harvesting equation, respectively. For example, LUX.Δt may be 1 when the illuminance is measured through sampling every 1 second. Therefore, the Charge[i][j].Δt value may be 1.

$$x = LUX . lux ( unit : lux ) \\ y = {10}^{a \times log ( x ) + b} ( unit : A ) \qquad [ Equation 5 ]$$

Afterward, using Equation 6, the amount of current y at the time point t and LUX.Δt and SBC.V are input to calculate an instantaneous energy generation amount E (unit: Ws) and Esum, which is the sum of instantaneous energies until the time point t.

$$E = LUX . Δ t \times SBC V ( unit : Ws ) \\ Esum = Esum + E ( unit : Ws ) \qquad [ Equation 6 ]$$

Next, using Equation 7, the voltage (V) and the current (I) of Charge[i][j] may be estimated as MaxE and Esum.

$${V}_{0} = SupCap V \\ {T}_{supercap} = \frac{Esum}{MaxE} \times 6. \\ {V}_{supercap} = {V}_{0} \times ( 1 - {e}^{- {T}_{supercap}} ) \\ {I}_{supercap} = \frac{Esum}{( {V}_{supercap} \times Δ t )} \\ Charge [ i ] [ j ] . ( V . I ) = ( {V}_{supercap} , {I}_{supercap} ) \qquad [ Equation 7 ]$$

A j-th Charge[i][j]=(t, V, I, Δt, E, Esum) element may be constructed. However, starting from LUX.t time point, for (LUX.t+m) seconds, elements from Charge[i][1] to Charge[i][m] are constructed. Until Charge[i][m].Esum, which is the last element, is equal to or greater than MaxE, that is, until the SuperCap fully charged with energy, m elements may be generated.

The apparatus may identify whether the total energy consumption (Esum) exceeds the maximum energy (MaxE) in step 913.

When the condition in step 913 is satisfied (True), the apparatus may generate a charge model. That is, the energy (SuperCapE) of the super capacitor may be set to the maximum energy (MaxE).

When the condition in step 913 is not satisfied (False), the apparatus determines whether j−1 is equal to or less than n and m is less than T2. When this is satisfied (True), the apparatus may perform step 905. When this is not satisfied (False), the apparatus may perform step 917.

After step 917, finally, the apparatus may return the time (T), charge model (Charge[i]), model (Model[k]), time gap (Delta[k]), event (Event[k]), and super capacitor energy (SuperCapE).

FIG. 10 shows a flowchart of a method of constructing a discharge model, according to an embodiment of the present disclosure.

Referring to FIG. 10, the apparatus may prepare energy data in step 1001. The energy data may include the time, indexes (i and k), voltage of the SuperCap, minimum voltage (MinE), job, energy consumption pattern (JobDelta), mode, time gap (Delta), and events. Specifically, the apparatus may read ImCAppE time series data, Job[i] time series data, and JobDelta[i] data. In addition, the variable values T, i, and k in step 609 of FIG. 6 and SuperCap energy (SuperCapE), which is the SuperCap full charge energy value, may be used as inputs. Using JobDelta[i].st and JobDelta[i].et values of the element with index i in the JobDelta table, ImCAppE time series data, specifically, (t, Δt, V, I) elements of time series data from ImCAppE[JobDelta[i].st] to ImCAppE[JobDelta[i].et], may be read in time order.

The apparatus may perform initialization in step 1003. For example, the job mode may be set to the discharge mode, the time gap may be set to 200 microseconds, the total energy consumption (Esum) may be initialized to the energy (SuperCapE) of the super capacitor, and the start and end times (T1 and T2) of a job may be set referring to JobDelta. In addition, variables related to Delta[k] may be initialized. This can be summarized as in Table 1 below.

TABLE 1

ImCModeEve ntDelt [symbol] k] MODE = discharge
V = SBC V
t = 0, Δt = powermoni toringtime(ex) 200 usec
Esum = SuperCapE
T1 = JobDelta[i].st, [symbol] = JobDelta[i].et
ImCModeEve ntDelt [symbol] k].DELTA .Δt = JobDelta[i].Δt,
ImCModeEve ntDelt [symbol] k] DELTA.st = T
ImCModeEve ntDelt [symbol] k] DELTA.et = 0,
j = 1, m = T1 [symbol]
indicates data missing or illegible when filed

The apparatus may read job energy consumption in step 1005. Specifically, the apparatus may read energy consumption voltage and current values of the application starting from the m time point in order. This can be summarized as in Table 2 below.

TABLE 2

T =T + Δt
t = t + Δt
V = ImCAppE [m ] .V
I = ImCAppE [m ] .I

The apparatus may calculate and subtract job energy consumption in step 1007. Specifically, the apparatus may calculate the job energy consumption (application energy consumption) and subtract the same from Esum. This can be summarized as in Table 3 below.

TABLE 3

E =V * I + Δt
Esum =Esum −E

The apparatus may generate and add a discharge element in step 1009. Specifically, the apparatus may generate and add the time, voltage, current, time gap, and total energy consumption. This can be summarized as in Table 4 below.

TABLE 4

Discharge[i][j]=(T, V, I [symbol] t, E, E [symbol] )
j= j+ 1,m =m + Δt ; [symbol]
indicates data missing or illegible when filed

The apparatus may identify whether Esum is equal to or less than MinE in step 1011.

In step 1011, when it is determined that Esum is equal to or less than MinE (True), the apparatus may generate a discharge model in step 1015. In step 1015, the apparatus may set Delta[k].et to the current time (T) and update the energy (SuperCapE) of the SuperCap with the total energy consumption (Esum).

In step 1011, when it is determined that Esum is greater than MinE (False), the apparatus may identify whether the end time (Job[m−1].t) of the current job is less than the total time (T2) in step 1013.

In step 1013, when it is identified that the end time of the current job is less than the total time, the apparatus may perform step 1005. In step 1013, when it is identified that the end time of the current job is equal to or greater than the total time, the apparatus may generate a discharge model in step 1015. In step 1015, the apparatus may set Delta[k].et to the current time (T) and update the energy (SuperCapE) of the SuperCap with the total energy consumption (Esum).

After step 1015, the apparatus may optimally return the time (T), discharge model (Discharge[i]), mode (Mode), time gap (Delta[k]), event (Event[k]), and energy (SuperCapE) of the SuperCap.

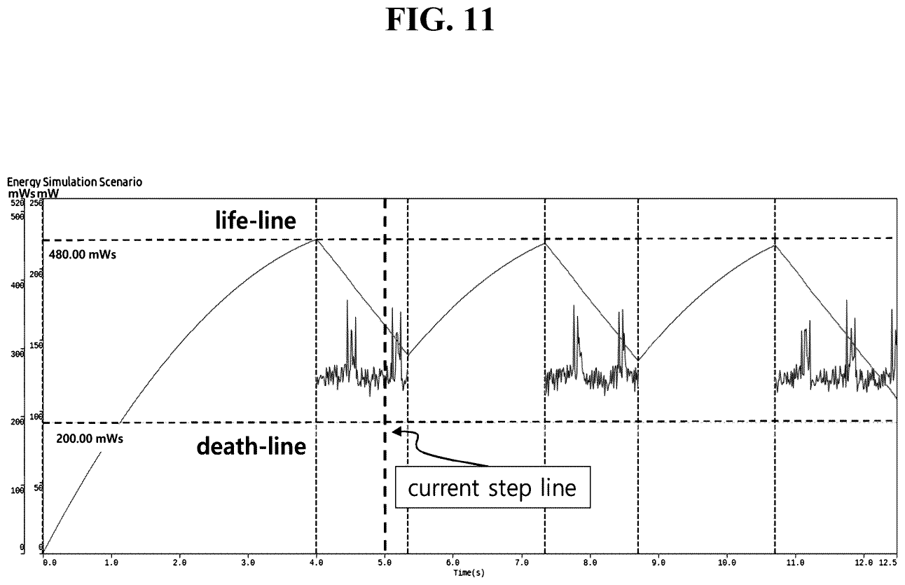

FIG. 11 shows another example of a job division operation, according to an embodiment of the present disclosure. Specifically, FIG. 11 shows another example of an intermittent computing scenario model with division into three jobs.

### [Intermittent Computing Energy Simulation Experiment and Statistical Analysis]

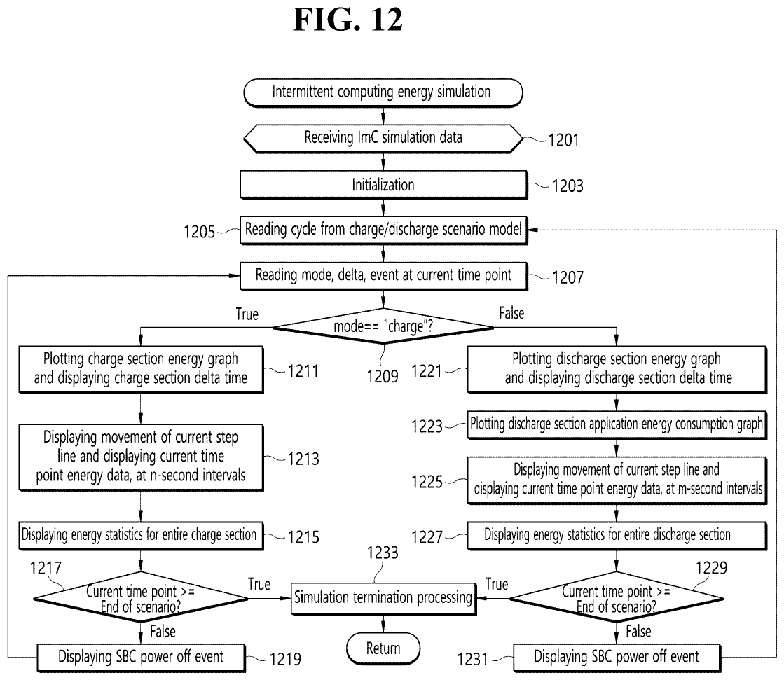

FIG. 12 shows an intermittent computing energy simulation operation method, according to an embodiment of the present disclosure. FIG. 12 shows an example of a method for examining a power instability situation of intermittent computing by performing a step-by-step simulation experiment based on step movement by Δt, through ImCScenModel constructed through a method of generating intermittent computing scenario model data.

Referring to FIG. 12, the apparatus may receive simulation data for intermittent energy simulation in step 1201. For example, data, such as ImCScenModel, Job, MaxE, and MinE shown in FIG. 6, may be prepared. In addition, the simulation step time for charge and discharge sections may be set. For example, the simulation step time in the charge section of ImC may be set to 10 seconds and that in the discharge section may be set to 1 second. The delta time of the charge section generally requires 1500 seconds or more in a situation with 2000 lux or more of sunlight. Therefore, when the charge trend is examined at 10-second intervals for simulation effect, a charge situation may be determined in 150 steps. Afterward, the discharge section is scheduled to be within several tens of seconds. Therefore, in this section, simulation is performed with step processing at 1-second intervals to help determine energy state changes over several tens of iterations.

The apparatus may initialize variables for simulation in step 1203. For example, the variables may be initialized as shown in Table 5 below.

TABLE 5

i=1, k=1, current=0, njobs=sizeof(JOB),
n=chargesteptime, m=dischargesteptime,
endtime = ImCScenModel[njobs].Discharge[njobs][last].t

The apparatus may read a cycle from a charge and discharge scenario model. Specifically, the apparatus may read a cycle model consisting of Charge[i] and Discharge[i] from the charge and discharge scenario model. For example, the cycle may be read as shown in Table 6 below.

TABLE 6

Cycle = ImCScenModel[i];

The apparatus may read the mode, delta, and event at the current time point in step 1207. In addition, the apparatus may set the current time point (current) to the start time (st) value of delta data.

TABLE 7

mode = ImCModeEventDelta[k].Mode
delta = ImCModeEventDelta[k].Delta
event = ImCModeEventDelta[k]Event
current = delta.st

The apparatus may identify whether the mode is the charge mode or the discharge mode. When the mode is the charge mode in step 1209, step 1211 is performed. Otherwise, step 1221 is performed.

The apparatus may perform plotting a charge section energy graph and displaying a charge section delta time in step 1211. For example, as shown in Table 8 below, the plotting of the charge section energy graph and the displaying of the charge section delta time may be performed.

TABLE 8

E = Cycle[i].Charge[i][:]
X=E [‘T’], Y=E[‘Esum’]
plotline(X,Y,delta. [symbol] t)

The apparatus may perform displaying movement of the current step line and displaying current time point energy data, at n-second intervals in step 1213.

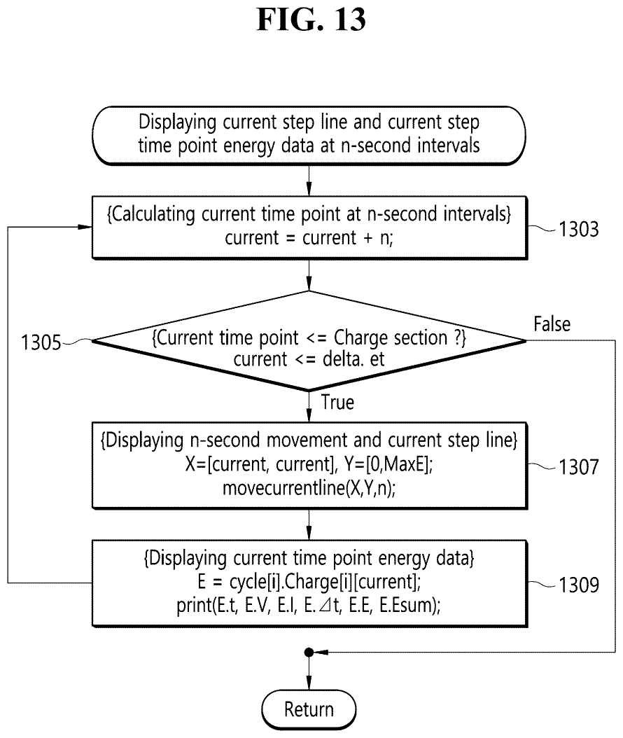

The detailed operation in step 1213 is shown in FIG. 13.

The apparatus may display energy statistics for the entire charge section in step 1215. For example, the apparatus may display the energy statistics for the entire charge section as shown in Table 9 below.

TABLE 9

average=compute_average_energy(E),
print(average.V, average.I, average.E);
k = k + 1;

The apparatus may identify whether the current time point is equal to or greater than the end of the scenario in step 1217.

In step 1217, when the current time point is equal to or greater than the end of the scenario, the step 1233 may be performed for simulation termination processing. When the current time point is less than the end of the scenario, an SBS power on event may be displayed in step 1219. After step 1219, the apparatus may perform step 1207.

In step 120, when the apparatus identifies the mode as the discharge mode, the apparatus may perform plotting a discharge section energy graph and displaying a discharge section delta time in step 1221. For example, as shown in Table 10 below, the apparatus may perform plotting a discharge section energy graph and displaying a discharge section delta time.

TABLE 10

E = Cycle[i].Discharge[i][:]
X=E[‘T’], Y=E[‘Esum’]
plotline(X,Y,delta. [symbol] t)

The apparatus may plot a discharge section application energy consumption graph in step 1223. For example, as shown in Table 11 below, the apparatus may plot the discharge section application energy consumption graph.

TABLE 11

X=E[‘T’][:], Y=Job[i][‘E’][:],
plotline(X,Y)

The apparatus may perform displaying the movement of the current step line and displaying current time point energy data, at m-second intervals in step 1225.

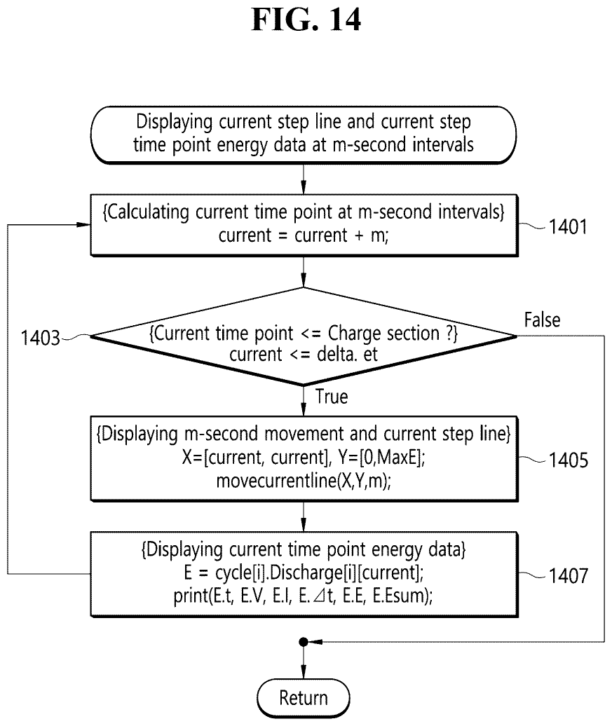

The detailed operation in step 1225 is shown in FIG. 14.

The apparatus may display energy statistics for the entire discharge section in step 1227. For example, as shown in Table 12 below, the apparatus may display the energy statistics for the entire discharge section.

TABLE 12

average=compute_average_energy(E),
print(average.V, average.I, average.E),
k = k + 1, i = i + 1

The apparatus may identify whether the current time point is equal to or greater than the end of the scenario in step 1229. When the current time point is equal to or greater than the end of the scenario, step 1233 may be performed for simulation termination processing. When the current time point is less than the end of the scenario, an SBC power off event may be displayed in step 1231.

The apparatus may perform simulation termination processing in step 1233, and return the simulation for termination.

FIG. 13 shows an operation method for displaying movement of a charge section current line and current time point energy data, according to an embodiment of the present disclosure. FIG. 13 shows step 1213 of FIG. 12 in more detail.

Referring to FIG. 13, the apparatus may calculate the current time point at n-second intervals in step 1303. That is, the current time point of energy consumption data may be increased by n to calculate a new current point.

The apparatus may identify whether the current time point is equal to or less than charge section in step 1305. When the condition in step 1305 is true, step 1307 is performed. When the condition is false, the operation method of FIG. 13 may terminate (return).

The apparatus may display n-second movement and the current step line in step 1307. That is, the movecurrentline function may be used to maintain the current time point, and the y axis may draw a line having the range from 0 to maximum energy (MaxE).

The apparatus may display current time point energy data in step 1309. That is, cycle[i] and charge[i] may be used to calculate the energy consumption E at the current time point, and E may be output. Herein, output values may include the energy (E), time (t), voltage (E.V), current (E.I), time gap (Δt), energy (E.E), and total energy consumption (E.Esum).

FIG. 14 shows an operation method for displaying movement of a discharge section current line and current time point energy data, according to an embodiment of the present disclosure. FIG. 14 shows step 1225 of FIG. 12 in more detail.

Referring to FIG. 14, the apparatus may calculate the current time point at m-second intervals in step 1401. That is, the current time point may be increased by m to calculate a new current time point.

The apparatus may identify whether the current time point is equal to or less than the charge section in step 1403. When the condition in step 1403 is true, the apparatus may perform step 1405. When the condition in step 1403 is false, the apparatus may terminate (return) the operation of FIG. 14.

The apparatus may display m-second movement and the current step line in step 1405. Specifically, the movecurrentline function may be called to display the graph with the current time on the x axis and a range from 0 to MaxE on the y axis.

The apparatus may display current time point energy data in step 1407. Specifically, referring to cycle[i] and discharge[i], the energy consumption (E) at the current time point may be calculated and output. Output values may include the energy (E), time (t), voltage (E.V), current (E.I), Δt, energy (E.E), and total energy consumption (E.Esum).

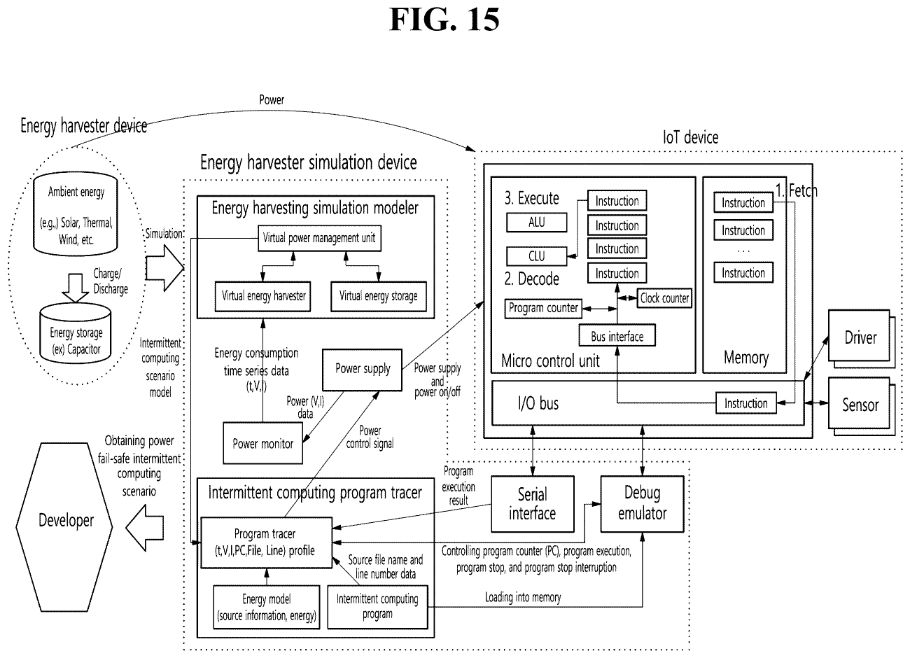

FIG. 15 shows a configuration diagram of an apparatus for simulating power instability in intermittent computing, according to various embodiments of the present disclosure.

The apparatus for simulating intermittent computing power instability may include an energy harvester device, an energy harvester simulation device, and an IoT device.

The energy harvester device may perform harvesting on an energy storage (e.g., capacitor) by charging the energy storage with ambient energy (e.g., the sun, heat, wind, and the like) and discharging the same. The energy harvested by the energy harvester device may be supplied to the energy harvester simulation device.

The energy harvester simulation device may include an energy harvesting simulation modeler, an intermittent computing program tracer, a power supply, a power monitor, a serial interface, and a debug emulator.

The energy harvesting simulation modeler may include a virtual power management unit, a virtual energy harvester, and a virtual energy storage.

The intermittent computing program tracer may include a program tracer profile, an intermittent computing program, and an energy model (e.g., source information, and energy).

The power supply may provide power to the IoT device and turn on/off the power, and may also provide power (V,I) data to the power monitor.

The power monitor may provide energy consumption time series data (t, V, I) to the energy harvesting simulation modeler.

The program tracer profile may receive program execution results through the serial interface, and may exchange signals with the debug emulator to control a program counter, program execution, program stop, and program stop interruption.

In addition, the program tracer profile may receive a source file name and line number data from the intermittent computing program, and may receive source information and energy from the energy model.

The program tracer profile receiving these may provide a power control signal to the power supply, and the power supply may supply power to the IoT device and turn on/off the power.

The IoT device is a general IoT device of the present technology, and may include a memory, a micro control unit, an I/O bus, a driver, and a sensor, which may perform general memory, micro control unit, I/O bus, driver, and sensor functions, respectively.

In addition, energy harvester simulation device may include at least one processor (not shown) for controlling the energy harvesting simulation modeler, the intermittent computer program tracer, the serial interface, the debug emulator, the power supply, and the power monitor.

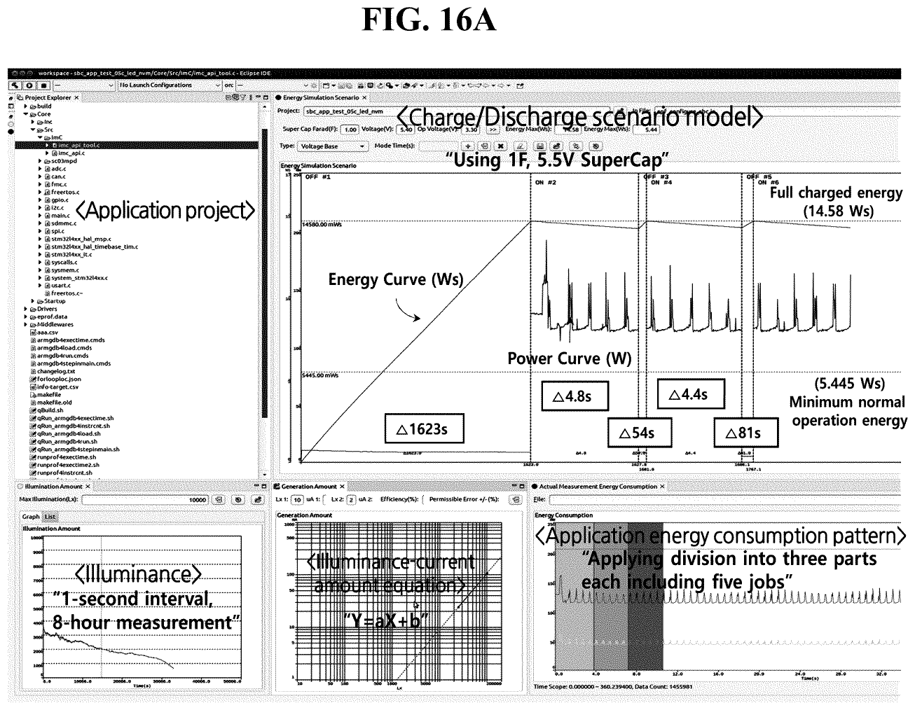

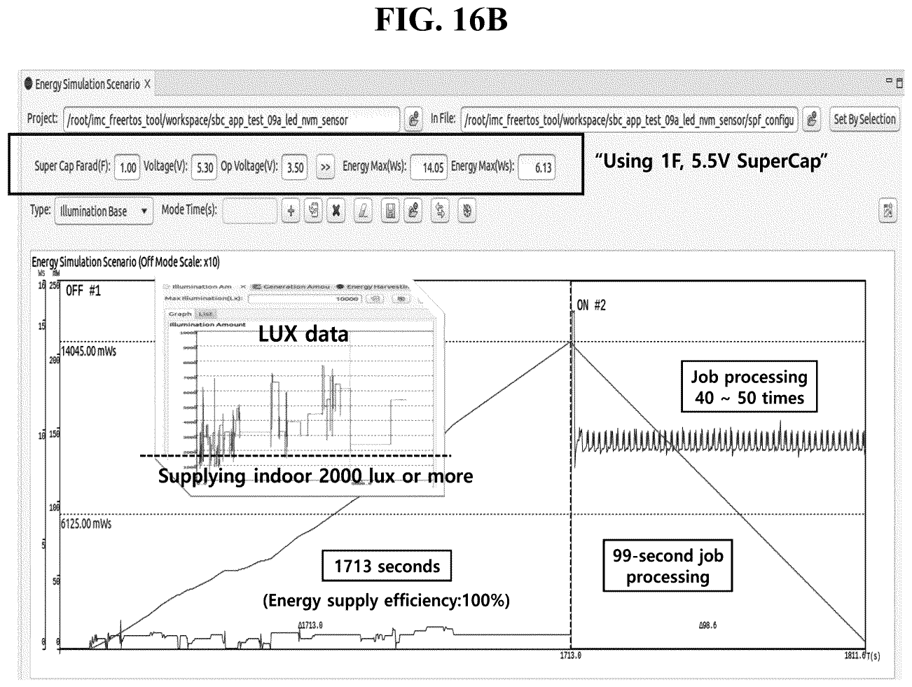

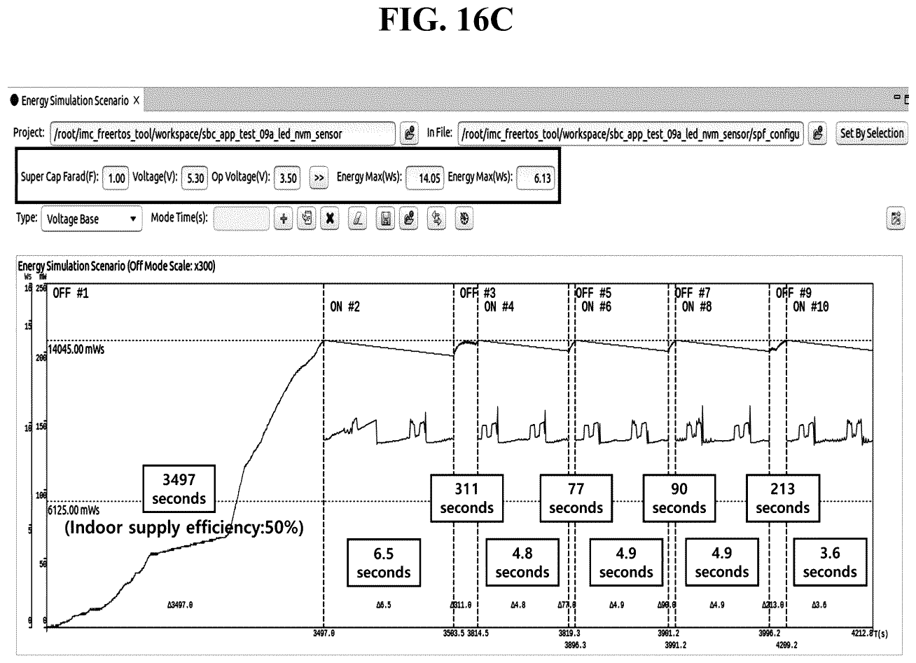

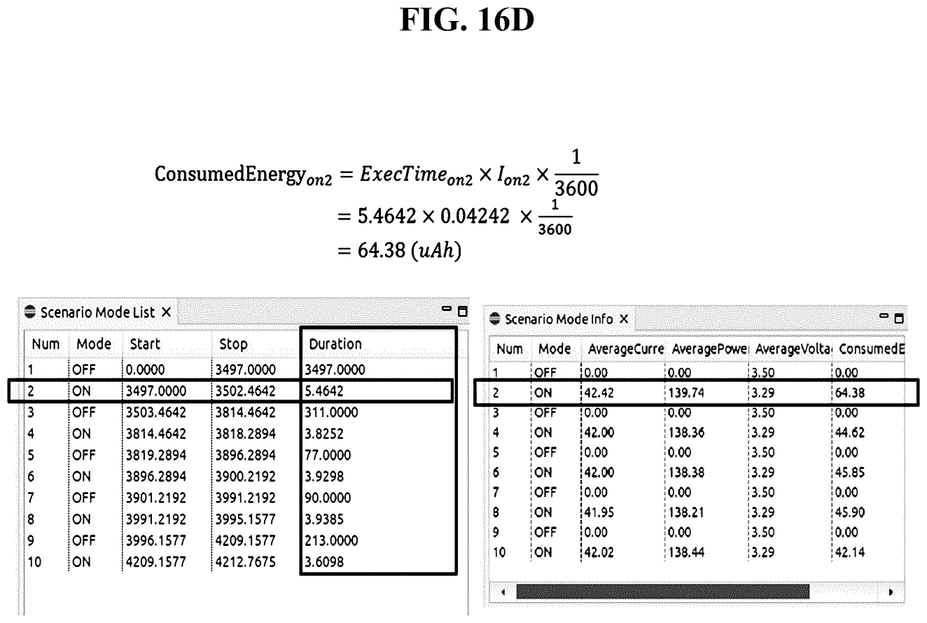

FIG. 16A shows a first example of a screen for simulating power instability in intermittent computing, according to an embodiment of the present disclosure.

Referring to FIG. 16A, FIG. 16A shows a visualized simulation screen according to particular-time (e.g., seconds or milliseconds) step movement. The screen of FIG. 16A may include an application project, a charge and discharge scenario model (using a 1 F, 5.5 V SuperCap), illuminance (measured at 1-second intervals, 8 hours), an illuminance-current amount equation (Y=ax+b), and an application energy consumption pattern (applying division into three parts each including five jobs).

FIG. 16B shows a second example of a screen for simulating power instability in intermittent computing, according to an embodiment of the present disclosure.

Referring to FIG. 16B, FIG. 16B shows a graph for an intermittent computing scenario model from initial charge to full discharge. FIG. 16B shows the use of a 1 F, 5.5 V SuperCap.

FIG. 16C shows a third example of a screen for simulating power instability in intermittent computing, according to an embodiment of the present disclosure.

Referring to FIG. 16C, FIG. 16C shows a graph for an intermittent computing scenario scheduled with job energy. Specifically, FIG. 16C shows modeling of energy scheduling with job processing twice and an intermittent computer scenario in an environment with indoor energy supply efficiency of 50%.

FIG. 16D shows a fourth example of a screen for simulating power instability in intermittent computing, according to an embodiment of the present disclosure.

Referring to FIG. 16D, FIG. 16D shows energy statistics for intermittent computing simulation. It can be seen that for index 2, consumption energy was 64.38 uAh.

Methods according to the embodiments described in the claims of the present disclosure or in the specification may be implemented in the form of hardware, software, or a combination of hardware and software.

In the case of software e implementation, a computer-readable storage medium in which at least one program (software module) is stored may be provided. The at least one program stored in the computer-readable storage medium is configured to be executable by at least one processor in an electronic device. The at least one program includes instructions for the electronic device to execute the methods according to the embodiments described in the claims of the present disclosure or the specification.

The program (software module or software) may be stored in non-volatile memory including random-access memory and flash memory, read-only memory (ROM), electrically erasable programmable read-only memory (EEPROM), a magnetic disc storage device, a compact disc-ROM (CD-ROM), digital versatile discs (DVDs), optical storage devices of other types, or a magnetic cassette. Alternatively, the program may be stored in a memory composed of a combination of some or all of these memories. In addition, a plurality of such memories may be included.

In addition, the program may be stored in an attachable storage device that is accessible through a communication network, such as the Internet, Intranet, a local area network (LAN), a wide area network (WAN), or a storage area network (SAN), or a combination thereof. The storage device may be connected through an external port to an apparatus performing an embodiment of the present disclosure. In addition, a separate storage device on the communication network may be connected to the apparatus performing an embodiment of the present disclosure.

In the above-described detailed embodiments of the disclosure, an elements included in the disclosure is expressed in the singular or the plural according to a presented detailed embodiment. However, the singular form or plural form is selected suitable for the presented situation for convenience of description, and the various embodiments of the disclosure are not limited to a single element or multiple elements thereof. Further, either multiple elements expressed in the description may be configured into a single element or a single element in the description may be configured into multiple elements.

Although the specific embodiments have been described in the detailed description of the present disclosure, various modifications and changes may be made thereto without departing from the scope of the present disclosure. Therefore, the scope of the present disclosure should not be defined as being limited to the embodiments, but should be defined by the appended claims and equivalents thereof.

### STATEMENT REGARDING PRIOR DISCLOSURES BY THE INVENTOR OR A JOINT INVENTOR

The inventors of the present application have made related disclosure in KWANGYONG LEE et al., “A Development of Simulation Analysis Tool for Solar-Panels Energy Harvesting Systems,” 2023 Fall Academic Conference of: Institute of Embedded Engineers of Korea, Nov. 19, 2023. The related disclosure was made less than one year before the effective filing date (Dec. 26, 2023) of the present application and the inventors of the present application are the same as those of the related disclosure. Accordingly, the related disclosure is disqualified as prior art under 35 USC 102(a) (1) against the present application. See 35 USC 102(b) (1) (A).

What is claimed is:

1. An operation method for simulating power instability in intermittent computing, the operation method comprising:
receiving at least one selected from a group of energy storage and SBC standard information of an intermittent computing system, energy consumption information for an application program of the intermittent computing system, and illuminance information;
generating an intermittent computing charge and discharge energy scenario model on the basis of the received information;
performing intermittent computing energy simulation on the basis of the generated model; and
identifying whether a result of the simulation is appropriate.

2. The operation method of claim 1, wherein the generating of the intermittent computing charge and discharge energy scenario model comprises:
dividing the received pieces of information by job to generate jobs;
generating, on the basis of the generated jobs, an intermittent computing charge energy scenario model included in the intermittent computing charge and discharge energy scenario model; and
generating, on the basis of the generated jobs, an intermittent computing discharge energy scenario model included in the intermittent computing charge and discharge energy scenario model.

3. The operation method of claim 2, wherein the dividing of the received pieces of information by job to generate the jobs comprises
arranging the received pieces of information in time series order and dividing the received pieces of information by job.

4. The operation method of claim 2, wherein the generating of the intermittent computing charge energy scenario model included in the intermittent computing charge and discharge energy scenario model comprises:
calculating an illuminance energy generation amount on the basis of the illuminance information;
calculating an energy sum and estimating a voltage or a current on the basis of the illuminance energy generation amount;
generating and adding a charge element on the basis of the energy sum and a voltage or current estimation value; and
generating the intermittent computing charge and discharge energy scenario model on the basis of the generated charge element.

5. The operation method of claim 3, wherein the generating of the intermittent computing discharge energy scenario model included in the intermittent computing charge and discharge energy scenario model comprises:
identifying energy consumption by job;
calculating the energy consumption by job;
generating and adding a discharge element on the basis of the calculated energy consumption by job; and
generating the intermittent computing discharge energy scenario model on the basis of the generated discharge element.

6. The operation method of claim 1, wherein the performing of the intermittent computing energy simulation on the basis of the generated model comprises
identifying whether a mode is a charge mode or a discharge mode on the basis of the intermittent computing charge and discharge energy scenario model.

7. The operation method of claim 6, further comprising
generating an energy graph corresponding to the charge mode when the mode is the charge mode.

8. The operation method of claim 6, further comprising
generating an energy graph corresponding to the discharge mode when the mode is the discharge mode.

9. The operation method of claim 1, wherein the identifying of whether the result of the simulation is appropriate comprises:
identifying a SuperCap optimal capacity of the intermittent computing system;
identifying the optimal number of times that job execution is performed in the intermittent computing system, and an optimal checkpoint execution time point; and
determining solar panel standards on the basis of at least one selected from a group of the SuperCap optimal capacity, the optimal number of times that job execution is performed, and the optimal checkpoint execution time point.

10. An apparatus for simulating power instability in intermittent computing, the apparatus comprising:
at least one processor,
wherein the at least one processor is configured to
receive at least one selected from a group of energy storage and SBC standard information of an intermittent computing system, energy consumption information for an application program of the intermittent computing system, and illuminance information,
generate an intermittent computing charge and discharge energy scenario model on the basis of the received information,
perform intermittent computing energy simulation on the basis of the generated model, and
identify whether a result of the simulation is appropriate.

11. The apparatus of claim 10, wherein the at least one processor is configured to, to generate the intermittent computing charge and discharge energy scenario model,
divide the received pieces of information by job to generate jobs,
generate, on the basis of the generated jobs, an intermittent computing charge energy scenario model included in the intermittent computing charge and discharge energy scenario model, and
generate, on the basis of the generated jobs, an intermittent computing discharge energy scenario model included in the intermittent computing charge and discharge energy scenario model.

12. The apparatus of claim 11, wherein the at least one processor is configured to, to divide the received pieces of information by job to generate the jobs,
arrange the received pieces of information in time series order and divide the received pieces of information by job.

13. The apparatus of claim 11, wherein the at least one processor is configured to, to generate the intermittent computing charge energy scenario model included in the intermittent computing charge and discharge energy scenario model,
calculate an illuminance energy generation amount on the basis of the illuminance information,
calculate an energy sum and estimate a voltage or a current on the basis of the illuminance energy generation amount,
generate and add a charge element on the basis of the energy sum and a voltage or current estimation value, and
generate the intermittent computing charge and discharge energy scenario model on the basis of the generated charge element.

14. The apparatus of claim 12, wherein the at least one processor is configured to, to generate the intermittent computing discharge energy scenario model included in the intermittent computing charge and discharge energy scenario model,
identify energy consumption by job,
calculate the energy consumption by job,
generate and add a discharge element on the basis of the calculated energy consumption by job, and
generate the intermittent computing discharge energy scenario model on the basis of the generated discharge element.

15. The apparatus of claim 10, wherein the at least one processor is configured to, to perform the intermittent computing energy simulation on the basis of the generated model,
identify whether a mode is a charge mode or a discharge mode on the basis of the intermittent computing charge and discharge energy scenario model.

16. The apparatus of claim 15, wherein the at least one processor is configured to generate an energy graph corresponding to the charge mode when the mode is the charge mode.

17. The apparatus of claim 15, wherein the at least one processor is configured to generate an energy graph corresponding to the discharge mode when the mode is the discharge mode.

18. The apparatus of claim 10, wherein the at least one processor is configured to, to identify whether the result of the simulation is appropriate,
identify a SuperCap optimal capacity of the intermittent computing system,
identify the optimal number of times that job execution is performed in the intermittent computing system, and an optimal checkpoint execution time point, and
determine solar panel standards on the basis of at least one selected from a group of the SuperCap optimal capacity, the optimal number of times that job execution is performed, and the optimal checkpoint execution time point.

19. A non-transitory computer-readable storage medium storing at least one program including instructions,
wherein when executed by an apparatus for simulating power instability in intermittent computing, the instructions cause the apparatus to
receive at least one selected from a group of energy storage and SBC standard information of an intermittent energy consumption information for a computing system, application program of the intermittent computing system, and illuminance information,
generate an intermittent computing charge and discharge energy scenario model on the basis of the received information,
perform intermittent computing energy simulation on the basis of the generated model, and
identify whether a result of the simulation is appropriate.

20. The non-transitory computer-readable storage medium of claim 19, wherein the instructions are to, to generate the intermittent computing charge and discharge energy scenario model,
divide the received pieces of information by job to generate jobs,
generate, on the basis of the generated jobs, an intermittent computing charge energy scenario model included in the intermittent computing charge and discharge energy scenario model, and
generate, on the basis of the generated jobs, an intermittent computing discharge energy scenario model included in the intermittent computing charge and discharge energy scenario model.
